(19) United States
(12) Patent Application Publication
(10) Pub. No.: US 2025/0212256 A1
(43) Pub. Date: Jun. 26, 2025

(54) TERMINAL APPARATUS, BASE STATION APPARATUS, AND COMMUNICATION METHOD

(71) Applicant: SHARP KABUSHIKI KAISHA, Sakai City, Osaka (JP)

(72) Inventors: TOMOKI YOSHIMURA, Sakai City, Osaka (JP); SHOHEI YAMADA, Sakai City, Osaka (JP); TOSHIZO NOGAMI, Sakai City, Osaka (JP)

(21) Appl. No.: 18/850,217

(22) PCT Filed: Oct. 31, 2022
(86) PCT No.: PCT/JP2022/040683

§ 371 Date: Sep. 24, 2024

(30) Foreign Application Priority Data
Dec. 15, 2021 (JP) 2021-203210

(51) Int. Cl. H04W 74/0816; H04L 27/26; H04W 80/02

(52) U.S. Cl. CPC H04W 74/0816; H04L 27/2605; H04W 80/02

(57) ABSTRACT

A MAC layer processing unit configured to recognize a service period configured in TWT, and a transmitter configured to perform transmission of a frame in the TWT are included. A maximum value of a contention window size is changed in carrier sense performed prior to the transmission of the frame, based on a condition related to the service period.

### TECHNICAL FIELD

The present invention relates to a terminal apparatus, a base station apparatus, and a communication method.

This application claims priority to JP 2021-203210 filed on Dec. 15, 2021, the contents of which are incorporated herein by reference.

### BACKGROUND ART

The Institute of Electrical and Electronics Engineers Inc. (IEEE) has been studying establishment of IEEE 802.11be, which serves as a subsequent standard of the IEEE 802.11 standard (NPL 1).

### CITATION LIST

### Non Patent Literature

NPL 1: “Proposed 802.11be Functional Requirements”, Huawei Technologies, 2 Feb. 2019.

### SUMMARY OF INVENTION

### Technical Problem

An aspect of the present invention provides a terminal apparatus and a base station apparatus that efficiently perform communication, and a communication method used for the terminal apparatus.

### Solution to Problem

(1) A first aspect of the present invention is a terminal apparatus. The terminal apparatus includes a MAC layer processing unit configured to recognize a service period configured in TWT, and a transmitter configured to perform transmission of a frame in the TWT. A maximum value of a contention window size is changed in carrier sense performed prior to the transmission of the frame, based on a condition related to the service period.

(2) A second aspect of the present invention is a base station apparatus. The base station apparatus includes a MAC layer processing unit configured to recognize a service period configured in TWT, and a transmitter configured to perform transmission of a frame in the TWT. A maximum value of a contention window size is changed in carrier sense performed prior to the transmission of the frame, based on a condition related to the service period.

(3) A third aspect of the present invention is a communication method used for a terminal apparatus. The communication method includes the steps of recognizing a service period configured in TWT, and performing transmission of a frame in the TWT. A maximum value of a contention window size is changed in carrier sense performed prior to the transmission of the frame, based on a condition related to the service period.

### Advantageous Effects of Invention

According to an aspect of the present invention, the terminal apparatus can efficiently perform communication. The base station apparatus can efficiently perform communication.

### BRIEF DESCRIPTION OF DRAWINGS

FIG. 1 is a conceptual diagram of a radio communication system 9 according to an aspect of the present embodiment.

FIG. 2 is a schematic block diagram illustrating a configuration example of a base station apparatus 3 according to an aspect of the present embodiment.

FIG. 3 is a schematic block diagram illustrating a configuration example of a terminal apparatus 1 according to an aspect of the present embodiment.

FIG. 4 is a diagram illustrating a configuration example of TWT in radio communication system #9 according to an aspect of the present embodiment.

FIG. 5 is a diagram illustrating an example of a count procedure according to an aspect of the present embodiment.

### DESCRIPTION OF EMBODIMENTS

An embodiment of the present invention will be described below.

floor(C) may be a floor function for a real number C. For example, floor(C) may be a function that outputs a maximum integer in a range of not exceeding the real number C. ceil(D) may be a ceiling function for a real number D. For example, ceil(D) may be a function that outputs a minimum integer in a range of not falling below the real number D. mod(E, F) may be a function that outputs a remainder obtained by dividing E by F. mod(E, F) may be a function that outputs a value corresponding to the remainder obtained by dividing E by F. exp (G)=e\hat{ }G. Here, e is a Napier's constant. H\hat{ }I represents H to the power of I. max(J, K) is a function that outputs a maximum value out of J and K. Here, in a case that J and K are equal, max(J, K) is a function that outputs J or K. min(L, M) is a function that outputs a maximum value out of L and M. Here, in a case that L and M are equal, min(L, M) is a function that outputs L or M. round(N) is a function that outputs an integer value of a value closest to N. “·” represents multiplication.

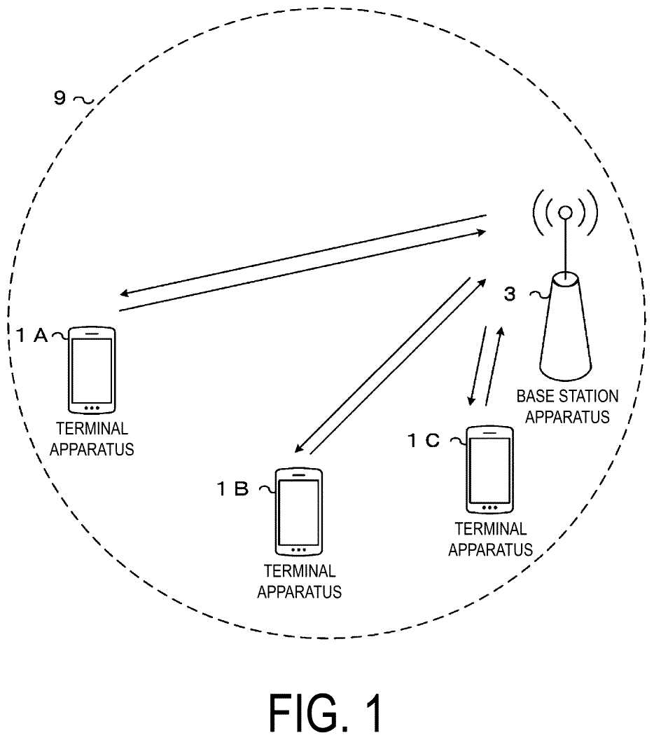

FIG. 1 is a conceptual diagram of a radio communication system 9 according to an aspect of the present embodiment. In FIG. 1, the radio communication system includes terminal apparatuses 1A to 1C and a base station apparatus 3 (Access Point #3 (AP #3)). Hereinafter, as a general term for the terminal apparatuses 1A to 1C, the terminal apparatuses communicating with the base station apparatus 3 are also referred to as a terminal apparatus 1 (Station #1 (STA #1)).

Note that, in the following, unless otherwise specifically noted, description will be given by using an example in which a frame is transmitted from the terminal apparatus 1 to the base station apparatus 3; however, various aspects of the present embodiment may be applied in a case that a frame is transmitted from the base station apparatus 3 to the terminal apparatus 1. Here, the terminal apparatus 1 may be referred to as a Non-AP STA. The base station apparatus may be referred to as an AP STA.

In the radio communication system 9, the terminal apparatus 1 and the base station apparatus 3 may perform communication, using Cyclic Prefix-Orthogonal Frequency Division Multiplex (CP-OFDM). The radio communication system 9 is also referred to as a Basic Service Set (BSS) #9.

As illustrated in FIG. 1, the base station apparatus 3 may include one transmission and/or reception apparatus (or transmission point, transmission apparatus, reception point, reception apparatus, transmission and/or reception point). On the other hand, in some cases, the base station apparatus 3 may include multiple transmission and/or reception apparatuses. In a case that the base station apparatus 3 includes multiple transmission and/or reception apparatuses, the multiple transmission and/or reception apparatuses may be arranged at geographically different positions.

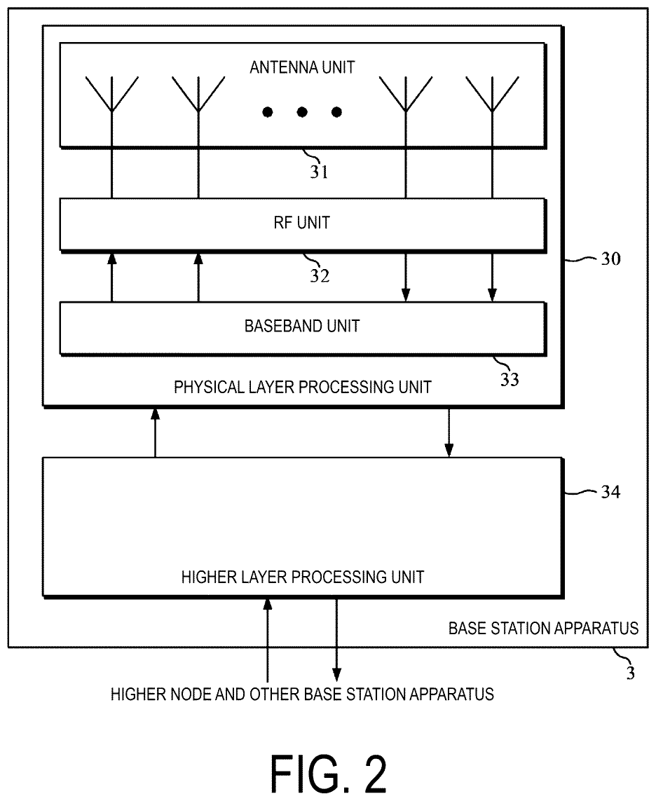

FIG. 2 is a schematic block diagram illustrating a configuration example of the base station apparatus 3 according to an aspect of the present embodiment. As illustrated in FIG. 2, the base station apparatus 3 includes a physical layer processing unit (radio transmission and/or reception unit) 30 and a higher layer processing unit 34. The physical layer processing unit 30 includes a part or all of an antenna unit 31, a Radio Frequency (RF) unit 32, and a baseband processing unit 33.

The physical layer processing unit 30 performs processing of the physical layer. Here, the processing of the physical layer may include OFDM baseband signal generation processing and frame detection processing. The frame is also referred to as a data unit.

The higher layer processing unit 34 performs processing of the Medium Access Control (MAC) layer. The processing of the MAC processing unit 34 includes a carrier sense mechanism.

The physical layer processing unit 30 may perform a part or all of modulation processing, coding processing, and transmission processing. The physical layer processing unit 30 may generate a frame, based on a part or all of coding processing, modulation processing, and baseband signal generation processing for an information bit sequence to be transmitted in the frame.

The physical layer processing unit 30 may perform one or both of demodulation processing and decoding processing. The physical layer processing unit 30 may detect, based on the demodulation processing and the decoding processing for a received frame. The physical layer processing unit 30 may perform carrier sense prior to transmission of a frame.

The RF unit 32 may convert a signal received via the antenna unit 31 into a baseband signal to remove unnecessary frequency components from the signal. The RF unit 32 outputs the baseband signal to the baseband unit 33.

The baseband unit 33 may digitize the baseband signal received from the RF unit 32. The baseband unit 33 may remove a portion of the digitized baseband signal corresponding to a Cyclic Prefix (CP). The baseband unit 33 may perform a Fast Fourier Transform (FFT) on the baseband signal from which the CP has been removed to extract a signal in the frequency domain.

The baseband unit 33 may generate a baseband signal by performing Inverse Fast Fourier Transform (IFFT) on the physical signal. The baseband unit 33 may add the CP to the generated baseband signal. The baseband unit 33 may convert the baseband signal to which the CP is added into an analog signal. The baseband unit 33 may output the converted analog baseband signal to the RF unit 32.

The RF unit 32 may remove unnecessary frequency components from the baseband signal received from the baseband unit 33. The RF unit 32 may generate an RF signal by up converting the baseband signal to a carrier frequency. The RF unit 32 may transmit an RF signal via the antenna unit 31. The RF unit 32 may have a function of controlling transmission power.

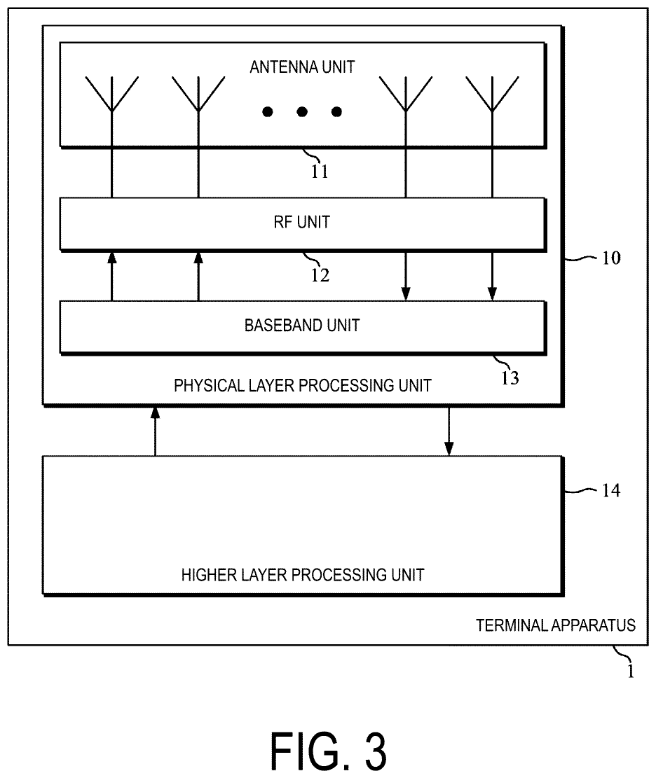

FIG. 3 is a schematic block diagram illustrating a configuration example of the terminal apparatus 1 according to an aspect of the present embodiment. As illustrated in FIG. 3, the terminal apparatus 1 includes a part or all of a physical layer processing unit (radio transmission and/or reception unit) 10 and a higher layer processing unit 14. The radio transmission and/or reception unit 10 includes a part or all of an antenna unit 11, an RF unit 12, and a baseband unit 13. The physical layer processing unit 10 performs processing of the physical layer. Here, the processing of the physical layer may include OFDM baseband signal generation processing and frame detection processing.

The higher layer processing unit 14 performs processing of the Medium Access Control (MAC) layer. The processing of the MAC processing unit 14 includes a carrier sense mechanism.

The physical layer processing unit 10 may perform a part or all of modulation processing, coding processing, and transmission processing. The physical layer processing unit 30 may generate a frame, based on a part or all of coding processing, modulation processing, and baseband signal generation processing for an information bit sequence to be transmitted in the frame.

The physical layer processing unit 10 may perform one or both of demodulation processing and decoding processing.

The physical layer processing unit 10 may detect, based on the demodulation processing and the decoding processing for a received frame.

The physical layer processing unit 10 may perform carrier sense prior to transmission of a frame.

The physical layer processing unit 10 may perform a part or all of modulation processing, coding processing, and transmission processing. The physical layer processing unit 10 may generate a physical signal, based on a part or all of coding processing, modulation processing, and baseband signal generation processing for an information bit sequence to be transmitted in the frame.

The physical layer processing unit 10 may perform one or both of demodulation processing and decoding processing.

The physical layer processing unit 10 may perform carrier sense prior to transmission of a frame.

The RF unit 12 may convert a signal received via the antenna unit 11 into a baseband signal to remove unnecessary frequency components from the signal. The RF unit 12 outputs the baseband signal to the baseband unit 13.

The baseband unit 13 may digitize the baseband signal received from the RF unit 12. The baseband unit 13 may remove a portion of the digitized baseband signal corresponding to a Cyclic Prefix (CP). The baseband unit 13 may perform Fast Fourier Transform (FFT) on the baseband signal from which the CP has been removed to extract a signal in the frequency domain.

The baseband unit 13 may generate a baseband signal by performing Inverse Fast Fourier Transform (IFFT) on the physical signal. The baseband unit 13 may add the CP to the generated baseband signal. The baseband unit 13 may convert the baseband signal to which the CP is added into an analog signal. The baseband unit 13 may output the converted analog baseband signal to the RF unit 12.

The RF unit 12 may remove unnecessary frequency components from the baseband signal received from the baseband unit 13. The RF unit 12 may generate an RF signal by up converting the baseband signal to the carrier frequency. The RF unit 12 may transmit an RF signal via the antenna unit 31. The RF unit 12 may have a function of controlling transmission power.

For management of radio resources in radio communication system #9, Target Wake Time (TWT) may be used. For example, it may be used for reduction of contention in radio communication system #9.

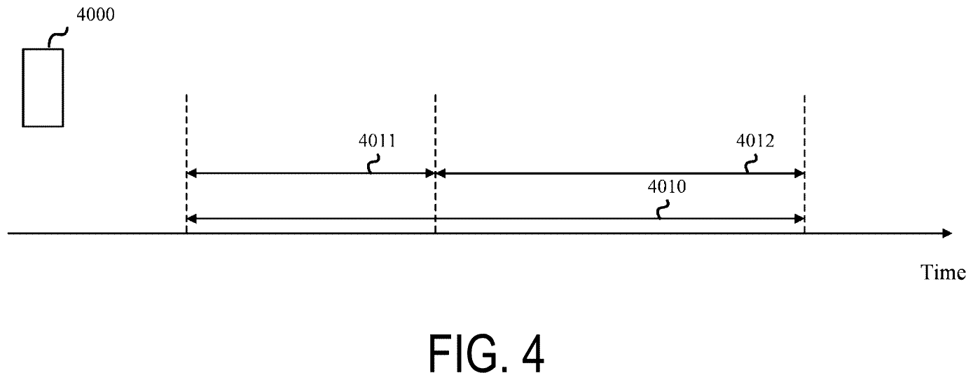

FIG. 4 is a diagram illustrating a configuration example of the TWT in radio communication system #9 according to an aspect of the present embodiment. In FIG. 4, the horizontal axis is a time axis. 4000 denotes a frame including information indicating a configuration of the TWT. For example, the frame 4000 may be a beacon frame.

In FIG. 4, 4010 denotes the TWT. The TWT 4010 is configured as a period in the time domain. For example, another TWT may start from the end of the TWT 4010. For example, the TWT may be periodically configured.

In FIG. 4, 4011 denotes a Service period. 4012 denotes a period other than the service period in the TWT 4010.

For example, the frame 4000 may include information indicating a length of the TWT and information indicating a length of the service period.

For example, the terminal apparatus 1 may configure the TWT 4010, based on the information indicating the configuration of the TWT 4010 included in the frame 4000. For example, the higher layer processing unit 14 may perform the carrier sense mechanism prior to transmission of frame.

The carrier sense mechanism may at least include one or both of processing related to an Inter-Frame Space (IFS) and a count procedure.

After the carrier sense mechanism is performed, the physical layer processing unit 10 may transmit the frame.

The procedure related to the IFS may be used to perform carrier sense and determine whether a medium is in an idle state or a busy state during a period being different and configured for each type of IFS. In other words, in the procedure related to the IFS, the physical layer processing unit 10 may perform carrier sense and determine whether a medium is in an idle state or a busy state. Carrier sense is a type of monitoring used by the physical layer processing unit 10. For example, in carrier sense, a certain preamble may be detected. Here, the preamble to be monitored in carrier sense may be a Short Training Sequence (STF). The STF is a preamble added at the start of a frame to be transmitted by the terminal apparatus 1. For example, the physical layer processing unit 10 may report “busy” to the higher layer processing unit 14, based on detection of the certain preamble by means of carrier sense. The physical layer processing unit 10 may report “idle” to the higher layer processing unit 14, based on no detection of the certain preamble by means of carrier sense.

For example, in carrier sense, the amount of detected energy may be monitored. Here, in a case that the amount of energy is detected in carrier sense, it may be used to determine whether a medium is in an idle state or a busy state, based on a comparison between the amount of energy and a threshold. For example, in carrier sense, based on the amount of energy measured in the medium being larger than the certain threshold, the physical layer processing unit 10 may report “idle” to the higher layer processing unit 14. In carrier sense, based on the amount of energy measured in the medium being smaller than the certain threshold, the physical layer processing unit 10 may report “busy” to the higher layer processing unit 14. In carrier sense, based on the amount of energy measured in the medium being equal to the certain threshold, the physical layer processing unit 10 may report either “busy” or “idle” to the higher layer processing unit 14.

The SIFS is a type of IFS. For example, an SIFS may include 16 microseconds. Here, a time length of the SIFS is also referred to as aSIFSTime.

A DIFS is a type of IFS. For example, the DIFS may include a time length calculated by aSIFSTime+2*aSlotTime. Here, aSlotTime is a time length configuring a slot to be used for carrier sense. For example, the time length configuring the slot may be 9 microseconds.

An AIFS is a type of IFS. For example, the DIFS may include a time length calculated by aSIFSTime+AIFSN(AC)*aSlotTime. Here, AIFSN(AC) is a value of the AIFSN in a case that the access category is AC. The value of the AIFSN may be different for each access category. Details of the AIFSN will be described later.

In the carrier sense mechanism, in a case that the SIFS is configured prior to transmission of a frame, the physical layer processing unit 10 need not perform carrier sense.

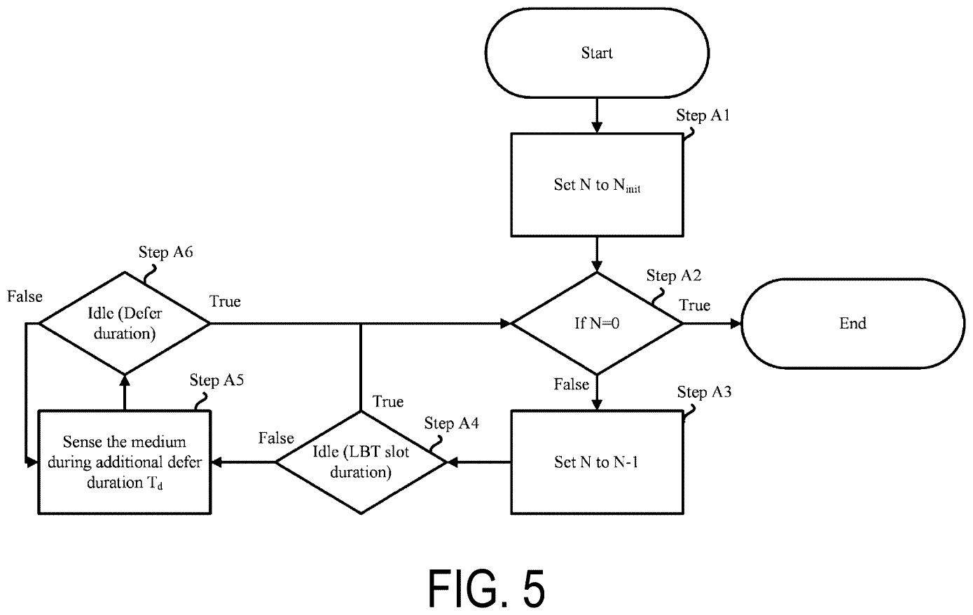

FIG. 5 is a diagram illustrating an example of the count procedure according to an aspect of the present embodiment. The count procedure is also referred to as a random backoff procedure. The count procedure at least includes a part or all of step A1 to step A6. Step A1 includes operation of setting a value of a counter N to Nᵢₙᵢₜ. Here, Nᵢₙᵢₜ is a value randomly (or pseudo-randomly) selected out of integer values included in the range from 0 to CW(AC). CWp is a Contention Window Size (CWS) for AC.

In step A2, whether or not the value of the counter N is 0 is determined. Step A2 includes operation of completing (or ending) the carrier sense mechanism in a case that the counter N is 0. Step A2 includes operation of proceeding to step A3 in a case that the counter N is different from 0. Here, True in FIG. 5 corresponds to a case that an evaluation expression is true in a step including operation of determining the evaluation expression. False corresponds to a case that an evaluation expression is false in a step including operation of determining the evaluation expression. In step A2, the evaluation expression corresponds to counter N=0.

For example, step A3 may include a step of decrementing the value of the counter N. To decrement the value of the counter N may mean that the value of the counter N is reduced by 1. In other words, to decrement the value of the counter N may mean that the value of the counter N is set to N−1.

For example, step A3 may include a step of decrementing the value of the counter N in a case that N>0. Step A3 may include a step of decrementing the value of the counter N in a case that the base station apparatus 3 or the terminal apparatus 1 selects to decrement the counter N. Step A3 may include a step of decrementing the value of the counter N in a case that N>0, and the base station apparatus 3 and the terminal apparatus 1 select to decrement the counter N.

For example, step A4 may include operation of performing carrier sense of a medium in a slot d, and proceeding to step A2 in a case that the slot d is idle. Step A4 may include operation of proceeding to step A2 in a case that the slot d is determined as idle by means of carrier sense. Step A4 may include operation of performing carrier sense in the slot d, and proceeding to step A5 in a case that the slot d is busy. Step A4 may include operation of proceeding to step A5 in a case that the slot d is determined as busy by means of carrier sense. Here, the slot d may be a slot, which is a slot period that follows an LBT slot period in which carrier sense is already performed in the count procedure. In step A4, the evaluation expression may correspond to a fact that the slot d is idle.

Step A5 includes operation of performing carrier sense until a medium is detected as busy in the processing related to the IFS.

Step A6 includes operation of proceeding to step A5 in a case that a medium is detected as busy in the processing related to the IFS. Step A6 includes operation of proceeding to step A2 in a case that a medium is detected as idle in the processing related to the IFS.

CWmin(AC) indicates a minimum value in a range of possible values of the contention window size CWp for an access category AC. CWmax(AC) indicates a maximum value in a range of possible values of the contention window size CWp for the access category AC. The contention window size CWp for the access category AC is also referred to as CWp.

The value of the counter N used in the carrier sense mechanism may be managed for each access category. For example, the terminal apparatus 1 may independently manage multiple access categories. For example, the terminal apparatus 1 may independently perform the random backoff procedure for each of the multiple access categories.

For example, the terminal apparatus 1 may manage the counter N for each of the multiple access categories. Here, the value of the counter N for the access category AC is also referred to as a counter N(AC).

In a case that a frame related to the access category AC is transmitted, CWp is managed by the base station apparatus 3 or the terminal apparatus 1, and CWp is adjusted (a procedure of adjusting CWp is performed) prior to step A1 of the count procedure.

Multiple access categories are defined. For example, the following may hold: CWmin(AC_BK)=aCWmin, CWmax(AC_BK)=aCWmax, and AIFSN(AC_BK)=9. The following may hold: CWmin(AC_BE)=aCWmin, CWmax(AC_BE)=aCWmax, and AIFSN(AC_BE)=6. The following may hold: CWmin(AC_VI)=(aCWmin+1)/2-1, CWmax(AC_VI)=aCWmin, and AIFSN(AC_VI)=3. The following may hold: CWmin(AC_VO)=(aCWmin+1)/4-1, CWmax(AC_VO)=(aCWmin+1)/2-1, and AIFSN(AC_VO)=2.

In this manner, values of various parameters to be used in the carrier sense mechanism may be set to be different for each access category. Such an access control method that the carrier sense mechanism is performed for each access category is also referred to as Enhanced Distributed Channel Access (EDCA).

In a case that the terminal apparatus 1 transmits a frame in the TWT 4010, the carrier sense mechanism is performed prior to transmission of the frame. Here, the terminal apparatus 1 may recognize the service period 4011 and perform the carrier sense mechanism.

For example, based on the terminal apparatus 1 recognizing the service period 4011 and the access category related to the frame, various parameters to be used in the carrier sense mechanism may be determined.

Here, based on whether or not a condition related to the service period 4011 is satisfied and the access category related to the frame, the terminal apparatus 1 may determine various parameters to be used in the carrier sense mechanism.

For example, the condition related to the service period 4011 may be one of the following condition 1 to condition 6:
Condition 1) A frame to be transmitted by the terminal apparatus 1 is included in the service period 4011;
Condition 2) A timing at which transmission of the frame is determined is included in the service period 4011;
Condition 3) A timing after an elapse of a prescribed period from the timing at which transmission of the frame is determined is included in the service period 4011.

For example, in condition 3, the prescribed period may be a period corresponding to an SHIS. For example, in condition 3, the prescribed period may be a period corresponding to a PIFS. For example, in condition 3, the prescribed period may be a period corresponding to a DIFS. For example, for example, in condition 3, the prescribed period may be a period corresponding to an AIFS corresponding to the access category having the highest priority among the access categories.

For example, based on whether or not the condition related to the service period 4011 is satisfied and the value of the access category related to the frame, the AIFSN may be determined. Here, “to determine the value of the AIFSN as 2” may be interpreted as “to use the DIFS”.

For example, in a case that the condition related to the service period 4011 is satisfied, and the access category related to the frame is AC_BK, the following may hold: AIFSN(AC_BK)=9.

For example, in a case that the condition related to the service period 4011 is not satisfied, and the access category related to the frame is AC_BK, the following may hold: AIFSN(AC_BK)=2.

For example, in a case that the condition related to the service period 4011 is satisfied, and the access category related to the frame is AC_BE, the following may hold: AIFSN(AC_BE)=6.

For example, in a case that the condition related to the service period 4011 is not satisfied, and the access category related to the frame is AC_BE, the following may hold: AIFSN(AC_BE)=3.

For example, in a case that the condition related to the service period 4011 is satisfied, and the access category related to the frame is AC_VI, the following may hold: AIFSN(AC_VI)=3.

For example, in a case that the condition related to the service period 4011 is not satisfied, and the access category related to the frame is AC_VO, the following may hold: AIFSN(AC_VO)=2.

For example, in a case that the condition related to the service period 4011 is satisfied, and the access category related to the frame is AC_VO, the following may hold: AIFSN(AC_VO)=2.

For example, in a case that the condition related to the service period 4011 is not satisfied, and the access category related to the frame is AC_VI, the following may hold: AIFSN(AC_VI)=2.

For example, based on whether or not the condition related to the service period 4011 is satisfied and the value of the access category related to the frame, CWmin may be determined. For example, in a case that the condition related to the service period 4011 is satisfied, and the access category related to the frame is AC_BK, the following may hold: CWmin(AC_BK)=aCWmin.

For example, in a case that the condition related to the service period 4011 is not satisfied, and the access category related to the frame is AC_BK, the following may hold: CWmin(AC_BK)=aCWmin.

For example, in a case that the condition related to the service period 4011 is satisfied, and the access category related to the frame is AC_BE, the following may hold: CWmin(AC_BE)=aCWmin.

For example, in a case that the condition related to the service period 4011 is not satisfied, and the access category related to the frame is AC_BE, the following may hold: CWmin(AC_BE)=aCWmin.

For example, in a case that the condition related to the service period 4011 is satisfied, and the access category related to the frame is AC_VI, the following may hold: CWmin(AC_VI) =(aCWmin+1)/2−1.

For example, in a case that the condition related to the service period 4011 is not satisfied, and the access category related to the frame is AC_VO, the following may hold: CWmin(AC_VO)=aCWmin.

For example, in a case that the condition related to the service period 4011 is satisfied, and the access category related to the frame is AC_VO, the following may hold: CWmin(AC_VO)=(aCWmin+1)/4−1.

For example, in a case that the condition related to the service period 4011 is not satisfied, and the access category related to the frame is AC_VI, the following may hold: CWmin(AC_VI)=aCWmin.

For example, based on the condition related to the service period 4011 being satisfied and the value of the access category related to the frame, CWmax may be determined. For example, in a case that the terminal apparatus 1 performs transmission of the frame in the service period 4011, and the access category related to the frame is AC_BK, the following may hold: CWmax(AC_BK)=aCWmax.

For example, in a case that the condition related to the service period 4011 is not satisfied, and the access category related to the frame is AC_BK, the following may hold: CWmax(AC_BK)=aCWmax.

For example, in a case that the condition related to the service period 4011 is satisfied, and the access category related to the frame is AC_BE, the following may hold: CWmax(AC_BE)=aCWmin.

For example, in a case that the condition related to the service period 4011 is not satisfied, and the access category related to the frame is AC_BE, the following may hold: CWmax(AC_BE)=aCWmin.

For example, in a case that the condition related to the service period 4011 is satisfied, and the access category related to the frame is AC_VI, the following may hold: CWmax(AC_VI) =(aCWmin+1)/2−1.

For example, in a case that the condition related to the service period 4011 is not satisfied, and the access category related to the frame is AC_VO, the following may hold: CWmax(AC_VO)=aCWmin.

For example, in a case that the condition related to the service period 4011 is satisfied, and the access category related to the frame is AC_VO, the following may hold: CWmax(AC_VO)=(aCWmin+1)/4−1.

For example, in a case that the condition related to the service period 4011 is not satisfied, and the access category related to the frame is AC_VI, the following may hold: CWmax(AC_VI)=(aCWmin+1)/2−1.

For example, based on whether or not the condition related to the service period 4011 is satisfied, the access category to which the frame belongs may be determined.

For example, in a case that the condition related to the service period 4011 is satisfied, and the type of the frame satisfies a first requirement, the terminal apparatus 1 may determine the access category related to the frame to AC_BK_X. For example, the first requirement may be non-time-critical, loss insensitive, and have a lower priority than Best effort.

For example, AIFSN(AC_BK_X) may be set to a value different from AIFSN(AC_BK). CWmin(AC_BK_X) may be set to a value different from CWmin(AC_BK). CWmax(AC_BK_X) may be set to a value different from CWmax(AC_BK).

For example, in a case that the condition related to the service period 4011 is not satisfied, and the type of the frame satisfies the first requirement, the terminal apparatus 1 may determine the access category related to the frame to AC_BK.

For example, in a case that the condition related to the service period 4011 is satisfied, and the type of the frame satisfies a second requirement, the terminal apparatus 1 may determine the access category related to the frame to AC_BE_X. For example, the second requirement may be non-time-critical and loss insensitive. The second requirement is also referred to as Best effort.

For example, AIFSN(AC_BE_X) may be set to a value different from AIFSN(AC_BE). CWmin(AC_BE_X) may be set to a value different from CWmin(AC_BE). CWmax(AC_BE_X) may be set to a value different from CWmax(AC_BE).

For example, in a case that the condition related to the service period 4011 is not satisfied, and the type of the frame satisfies the second requirement, the terminal apparatus 1 may determine the access category related to the frame to AC_BE.

For example, in a case that the condition related to the service period 4011 is satisfied, and the type of the frame satisfies a third requirement, the terminal apparatus 1 may determine the access category related to the frame to AC_VI_X. For example, the third requirement may be a condition that is time-critical, loss sensitive, and requires a delay of 100 ms or less.

For example, AIFSN(AC_VI_X) may be set to a value different from AIFSN(AC_VI). CWmin(AC_VI_X) may be set to a value different from CWmin(AC_VI). CWmax(AC_VI_X) may be set to a value different from CWmax(AC_VI).

For example, in a case that the condition related to the service period 4011 is not satisfied, and the type of the frame satisfies the third requirement, the terminal apparatus 1 may determine the access category related to the frame to AC_VI.

For example, in a case that the condition related to the service period 4011 is satisfied, and the type of the frame satisfies a fourth requirement, the terminal apparatus 1 may determine the access category related to the frame to AC_VO_X. For example, the fourth requirement may be a condition that is time-critical, loss sensitive, and requires a delay of 10 ms or less.

For example, AIFSN(AC_VO_X) may be set to a value different from AIFSN(AC_VO). CWmin(AC_VO_X) may be set to a value different from CWmin(AC_VO). CWmax(AC_VO_X) may be set to a value different from CWmax(AC_VO).

For example, in a case that the condition related to the service period 4011 is not satisfied, and the type of the frame satisfies the fourth requirement, the terminal apparatus 1 may determine the access category related to the frame to AC_VO.

For example, based on whether or not the condition related to the service period 4011 is satisfied, an access category set to which the frame belongs may be determined.

For example, with the condition related to the service period 4011 being satisfied, the terminal apparatus 1 may select a first access category set. For example, the first access category set may include a part or all of AC_BK_X, AC_BE_X, AC_VI_X, and AC_VO_X.

For example, with the condition related to the service period 4011 not being satisfied, the terminal apparatus 1 may select a second access category set. For example, the second access category set may include a part or all of AC_BK, AC_BE, AC_VI, and AC_VO.

Based on the requirement corresponding to the frame to be transmitted, the terminal apparatus 1 may select one access category out of one or multiple access categories included in the selected access category set.

Various aspects of apparatuses according to an aspect of the present embodiment will be described below.
(1) In order to accomplish the object described above, an aspect of the present invention is contrived to provide the following means. That is, a first aspect of the present invention is a terminal apparatus. The terminal apparatus includes a MAC layer processing unit configured to recognize a service period configured in TWT, and a transmitter configured to perform transmission of a frame in the TWT. A maximum value of a contention window size is changed in carrier sense performed prior to the transmission of the frame, based on a condition related to the service period.
(2) In the first aspect of the present invention, in a case that the frame belongs to a first access category, and the transmission of the frame is to be performed in the service period, the maximum value is set equal to a first value. In a case that the frame belongs to the first access category, and the transmission of the frame is not to be performed in the service period, the maximum value is set equal to a second value. In a case that the frame belongs a second access category, the maximum value is set equal to the second value.
(3) In the first aspect of the present invention, an access category related to the frame is determined based on the condition related to the service period.
(4) A second aspect of the present invention is a base station apparatus. The base station apparatus includes a MAC layer processing unit configured to recognize a service period configured in TWT, and a transmitter configured to perform transmission of a frame in the TWT. A maximum value of a contention window size is changed in carrier sense performed prior to the transmission of the frame, based on a condition related to the service period.
(5) In the second aspect of the present invention, in a case that the frame belongs to a first access category, and the transmission of the frame is to be performed in the service period, the maximum value is set equal to a first value. In a case that the frame belongs to the first access category, and the transmission of the frame is not to be performed in the service period, the maximum value is set equal to a second value. In a case that the frame belongs a second access category, the maximum value is set equal to the second value.
(6) In the second aspect of the present invention, an access category related to the frame is determined based on the condition related to the service period.

A program running on the base station apparatus 3 and the terminal apparatus 1 according to an aspect of the present invention may be a program (a program that causes a computer to function) that controls a Central Processing Unit (CPU) and the like so as to implement the functions of the above-described embodiment according to an aspect of the present invention. The information handled in these apparatuses is temporarily loaded into a Random Access Memory (RAM) while being processed, is then stored in a Hard Disk Drive (HDD) and various types of Read Only Memory (ROM) such as a Flash ROM, and is read, modified, and written by the CPU, as necessary.

Note that the terminal apparatus 1 and the base station apparatus 3 according to the above-described embodiment may be partially implemented by a computer. In that case, this configuration may be implemented by recording a program for implementing such control functions on a computer-readable recording medium and causing a computer system to read the program recorded on the recording medium for execution.

Note that it is assumed that the “computer system” mentioned here refers to a computer system built into the terminal apparatus 1 or the base station apparatus 3, and the computer system includes an OS and hardware components such as peripheral devices. In addition, the “computer-readable recording medium” refers to a portable medium such as a flexible disk, a magneto-optical disk, a ROM, and a CD-ROM, and a storage apparatus such as a hard disk built into the computer system.

Moreover, the “computer-readable recording medium” may include a medium that dynamically stores a program for a short period of time, such as a communication line in a case that the program is transmitted over a network such as the Internet or over a communication line such as a telephone line, and may also include a medium that stores the program for a certain period of time, such as a volatile memory included in the computer system functioning as a server or a client in such a case. In addition, the above-described program may be one for implementing some of the above-described functions, and also may be one capable of implementing the above-described functions in combination with a program already recorded in a computer system.

Furthermore, the base station apparatus 3 according to the aforementioned embodiment may be implemented as an aggregation (apparatus group) including multiple apparatuses. Each of the apparatuses included in such an apparatus group may include a part or all of each function or each functional block of the base station apparatus 3 according to the aforementioned embodiment. As the apparatus group, it is only necessary to have all of functions or functional blocks of the base station apparatus 3. Moreover, the terminal apparatus 1 according to the aforementioned embodiment can also communicate with the base station apparatus as the aggregation.

Also, the base station apparatus 3 according to the aforementioned embodiment may be an Evolved Universal Terrestrial Radio Access Network (EUTRAN) and/or a NextGen RAN (NG-RAN or NR RAN). Moreover, the base station apparatus 3 according to the aforementioned embodiment may have a part or all of the functions of a higher node for an eNodeB and/or a gNB.

Also, a part or all portions of each of the terminal apparatus 1 and the base station apparatus 3 according to the aforementioned embodiment may be implemented as an LSI, which is typically an integrated circuit, or may be implemented as a chip set.

The functional blocks of each of the terminal apparatus 1 and the base station apparatus 3 may be individually implemented as a chip, or a part or all of the functional blocks may be integrated into a chip. Furthermore, a circuit integration technique is not limited to the LSI and may be implemented with a dedicated circuit or a general-purpose processor. Moreover, in a case that a circuit integration technology that substitutes an LSI appears with the advance of the semiconductor technology, it is also possible to use an integrated circuit based on the technology.

In addition, although the aforementioned embodiments have described the terminal apparatus as an example of a communication apparatus, the present invention is not limited to such a terminal apparatus, and is also applicable to a terminal apparatus or a communication apparatus that is a stationary type or a non-movable type electronic apparatus installed indoors or outdoors, for example, such as an AV device, a kitchen device, a cleaning or washing machine, an air-conditioning device, office equipment, a vending machine, and other household appliances.

Although, the embodiments of the present invention have been described in detail above referring to the drawings, the specific configuration is not limited to the embodiments and includes, for example, design changes within the scope that do not depart from the gist of the present invention. For an aspect of the present invention, various modifications are possible within the scope of the claims, and embodiments that are made by suitably combining technical means disclosed according to the different embodiments are also included in the technical scope of the present invention. In addition, a configuration in which elements described in the respective embodiments and having mutually similar effects are substituted for one another is also included.

### INDUSTRIAL APPLICABILITY

An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

1 (1A, 1B, 1C) Terminal apparatus
3 Base station apparatus
9 Radio communication system
10, 30 Physical layer processing unit
10a, 30a Radio transmitting unit
10b, 30b Radio receiving unit
11, 31 Antenna unit
12, 32 RF unit
13, 33 Baseband unit
14, 34 Higher layer processing unit
4000 Frame
4010 TWT
4011 Service period
4012 Period

1. A terminal apparatus comprising:
a transmitter circuitry configured to transmit a data unit after performing carrier sensing, and
a MAC layer processing circuitry configured to use an access category related to the data unit during a service period of a Target Wake Time (TWT), wherein
the MAC layer processing circuitry decides the access category related to the data unit based on the service period of the TWT.

2. The terminal apparatus according to claim 1, wherein
the MAC layer processing circuitry configured to decide one or more parameters for performing carrier sensing corresponding to the access category.

3-6. (canceled)

7. A communication method used for a terminal apparatus, the communication method comprising the steps of:
transmitting a data unit after performing carrier sensing, and
using an access category related to the data unit during a service period of a Target Wake Time (TWT), wherein
the access category related to the data unit is decided based on the service period of the TWT.
